(19) United States
(12) Patent Application Publication
(10) Pub. No.: US 2026/0202363 A1
(43) Pub. Date: Jul. 16, 2026

(54) METHOD AND DEVICE FOR CARRYING OUT A SPECTRAL ANALYSIS FOR DETERMINING A SPECTRUM OF A SAMPLE

(71) Applicants: Helmut Fischer GmbH Institut fuer Elektronik und Messtechnik, Sindelfingen (DE); Karlsruher Institut fuer Technologie, Karlsruhe (DE)

(72) Inventors: Xiang Xie, Karlsruhe (DE); Wilhelm Stork, Landau (DE); Lars Anklamm, Berlin (DE); Malte Wansleben, Berlin (DE)

(21) Appl. No.: 19/136,418

(22) PCT Filed: Dec. 6, 2023
(86) PCT No.: PCT/IB2023/062314

§ 371 Date: Jun. 6, 2025

(30) Foreign Application Priority Data
Dec. 6, 2022 (DE) 10 2022 132 402.8

(51) Int. Cl. G01N 23/223

(52) U.S. Cl. CPC G01N 23/223; G01N 2223/076

(57) ABSTRACT

The invention relates to a method and a device for carrying out a spectral analysis for evaluating a spectrum of a sample (12), with a measuring device (11) in which a primary radiation (15) is directed from a source (14) onto the sample (12), in which a secondary radiation (17) is emitted from the sample (12) or at least one layer (13) of the sample as a result of the excitation of the sample (12) by means of primary radiation (15), in which a spectrum of the secondary radiation (17) is detected by a detector (18), in which the at least one detected spectrum is fed by the detector (18) to a computer-assisted evaluation device (21) for evaluation, in which the at least one detected spectrum is evaluated in at least one analyzing neural network (22) of at least one first network architecture (26) which is trained for quantitative analysis of the spectrum, in which the neural network (22) of the first network architecture (26) is trained by a plurality of simulation spectra which are generated on the basis of a physical model (S=P(φ)) using a simulation method, in which at least a second network architecture (41) is trained with a second analyzing neural network (46) for the qualitative analysis of the detected spectrum, in which a result for the at least one element concentration and/or the at least one element identification of the sample (12) is output from the spectrum analyzed by the neural networks (22, 46).

The invention relates to a method and a spectral analysis device for determining a spectrum of a sample.

In a spectral analysis, spectra of a sample are determined using a spectrometer of a measuring device, which contain information about the physical properties of the sample. These spectra are evaluated in order to determine, for example, an element concentration in a layer on the sample or in the sample as well as the presence of chemical elements. These processes must be carried out in a short time and with a high degree of repeatability in order to enable reliable conclusions to be drawn from the measurement carried out. It is therefore a fundamental aim to improve the quantitative analysis and/or the qualitative analysis in such a spectral analysis and to reduce the time required for this spectral analysis.

Previously, the determination of an element concentration in the sample was carried out, for example, by means of an iterative evaluation procedure. As a result, a number of parameters were selected in a physical model and used as a basis. The measured spectrum was then compared with a theoretical spectrum resulting from the physical model and, after an iterative optimization of the parameters, a result was output that represents a parameter set that corresponds to the best match between the measurement and the theoretical spectrum. This iteration procedure is time-consuming and cost-intensive.

The invention is based on the task of proposing a method and a device for carrying out a spectral analysis to determine a spectrum of a sample in order to enable at least a rapid and precise quantitative analysis.

This task is solved by a method for carrying out a spectral analysis to determine a spectrum of a sample, at in which at least the one detected spectrum is fed to and evaluated by at least a first network architecture with an analyzing neural network, which is trained for a quantitative analysis of the spectrum. The first network architecture is trained by a plurality of simulation spectra, which are generated on the basis of the existing physical model S=P(φ) using a simulation method.
become.

Furthermore, at least a second network architecture is trained with a second neural network for a qualitative analysis of the spectrum. Thus, in one process step, both the quantitative and the qualitative analysis can be performed and a result for the at least one element concentration and/or the at least one element identification of the sample can be output with a high accuracy/reliability.

The first and second network architectures can be structured differently.

The analyzing neural network of the at least one network architecture is preferably trained to approximate an inverse function P⁻¹(S) of a physical model S=P(T,λ,K), so that in the quantitative analysis at least one element concentration or layer thickness of the sample from which the spectrum was recorded is output and/or in the qualitative analysis the presence or absence of at least one chemical element in the sample is determined and output. To carry out the quantitative analysis, it was previously necessary to analyze the spectrum using the physical model, whereby all relevant parameters had to be known. This model corresponds abstractly to the equation S=P(φ), where the spectrum S is a non-linear function P of φ and φ stands for all variables that are to be determined, as for example, the concentration of all relevant elements and, if applicable, the thickness of the layer. The aim of the quantitative analysis is to determine φ for a measured spectrum under the given measurement conditions of a known measuring instrument or device. It was recognized that an inverse function P⁻¹(S) is required to determine the variable φ without iteration. By training the analyzed neural network on this inverse function, a fast and precise quantitative analysis for at least one element concentration of the sample and/or a qualitative analysis for the absence or presence of at least one element in the sample can be made possible.

Furthermore, it is preferably provided that the first network architecture is trained by a plurality of simulation spectra, which are generated based on the existing physical model S=P(θ, T, λ, K) using the simulation method, in particular a Monte Carlo simulation, and/or that the first network architecture is trained with a plurality of actually detected spectra. Training the neural network of the first network architecture with a large number of simulation spectra requires a one-off increase in time and possibly increased computing power, but the evaluation time for each detected spectrum can be significantly reduced after training the first network architecture.

The simulation spectra are preferably determined at least with relevant and/or predetermined parameters, such as the concentration of the chemical element or concentration of the at least one element of an alloy, element-specific physical constants, the layer thickness of the at least one layer, different measuring conditions of the measuring devices and/or characteristic properties of different measuring devices and/or device-specific data from the one or different measuring devices.

Furthermore, it is preferably provided that the second network architecture for the qualitative analysis is trained with a plurality of simulation spectra, which represent a plurality of intensity distributions of energy spectra of the chemical elements, which in particular deviate from each other. It is preferable that the network architecture is not trained for all existing chemical elements of the periodic table of elements (PSE), but for a specific selection of elements that are required to evaluate a spectrum. In particular, specific chemical elements can be selected for X-ray fluorescence analysis, for example those with an atomic number greater than 9. For other spectral analyses, chemical elements adapted accordingly can be selected.

The first network architecture for quantitative analysis is preferably set up in such a way that the detected spectrum is scaled with a scaling network with a scaling factor in order to compensate for various possible excitation conditions, in order to subsequently feed the scaled spectrum to a prediction network and output a result from the detected spectrum through this prediction network. This again enables a more precise quantitative determination of the network.

A neural network is used for the prediction network and/or the scaling network, preferably a convolutional network (DenseNet). This enables a shorter simulation time.

A feature reduction method is preferably used for the quantitative and/or qualitative analysis of the detected spectrum in order to generate preprocessed simulation spectra. This feature reduction method in turn serves to accelerate the training process.

Furthermore, it is envisaged that in the second network structure, starting from a plurality of spectra which are preprocessed using one of the feature reduction methods, for example a multilayer network (MLP), a convolutional neural network (CNN) or a dense convolutional neural network (DenseNet) is trained. In particular, it has been shown to be advantageous for setting up the second network structure that a feature selection is carried out as a feature reduction method and a DenseNet is then selected and trained.

In one of the feature reduction methods, it may be provided that the number of features to be evaluated of the already generated spectra, which each comprise a number of, for example, 1024 features, is reduced to a number of preferably 512, 256, 128, 64, 32 or 16 features. The features of a spectrum are also understood to be the frequencies or the energies correlating with them, which are output as so-called channels, particularly when A/D converters are used for the detector, whereby the channels are to be equated with the features.

Another feature reduction method that can be used is a mean value compression, in which the number of features in the recorded spectrum is reduced to a target spectrum with a reduced number of features by averaging.

Furthermore, the feature reduction method can be carried out as a feature selection in which a reduction of the number of features or channels of the respective spectrum is performed based on their original size of the generated spectrum. The generated spectrum is one that was produced by the simulation method described above.

Alternatively, a feature transformation can be carried out, in particular with an autoencoder network, in which the features respectively channels of the respective spectrum are weighted according to relevant and non-relevant features and the non-relevant features are eliminated

Using the aforementioned feature reduction methods, approximately similar performance results in the accuracy and precision of the results can be achieved within a range in which the features of the spectrum are reduced, for example, from 1024 to up to 32 features, which are advantageously 0.92 to 0.98 in an evaluation range of 0 to 1.

In feature selection as a feature reduction method, a Watermelon model is preferably selected, in which the selection of features for selection is preferably carried out by Bayesian error rate estimation.

Furthermore, it is preferred that the analyzing neural network is trained with a model for network reduction. Preferably, the neural network is reduced by components such as neurons, filters and/or parameters, in particular to eliminate redundant components. This can also enable a reduction in the required resources.

Furthermore, it is preferred that the analysing neural network is trained with a model for quantization in which the data size, in particular of a node of the neural network, is reduced. Preferably, a bit size of 32 bits (32 bit floats) or less is selected.

The aforementioned feature reduction methods, which are preferably carried out after training the neural network of the first and/or second network architecture, can be used individually or in any combination or even cumulatively.

The aforementioned feature reduction methods can reduce the size of the respective neural network used, whereby the evaluation results have become the same or better. The at least one feature reduction method can enable improved precision and shortened evaluation of the measurements on samples with a considerable reduction in data and computer costs.

Furthermore, it is preferably provided that a neural network of a meta-network is trained by simulation data from a number of known devices for performing a meta-learning procedure. Known devices are understood to be those that have already been calibrated and preferably at least one characteristic property of the device has already been determined. This makes it possible to minimize the calibration costs of the devices, especially when manufacturing a large number of devices or measuring devices.

Furthermore, it is preferable that a meta-learning method is used with the meta-network to calibrate unknown measuring devices for spectral analysis or devices, in which the properties and/or the changing measurement conditions and/or the measurement tasks of the unknown measuring device are recorded and the neural network of the meta-network is additionally trained using this simulation data and/or measured data of the unknown measuring device. The duration of the training of the meta-network by simulation data of the unknown measuring device is significantly reduced compared to the duration of the training for at least one neural network for the unknown measuring device. After training the meta-network to calibrate the unknown network, the device is ready for quantitative and/or qualitative analysis. Unknown devices are preferably understood to be devices that have been completed in production but not yet calibrated.

For the present method, a multilayer network (MLP—Multilayer Perceptron), a convolutional neural network (CNN—Convolutional Neural Network) or a dense neural network (DNN—Dense Neural Network), in particular a dense convolutional network (DenseNet—Dense Convolutional Network), can be used to form the analyzing neural network.

Furthermore, to carry out the spectral analysis, it is preferable for the qualitative analysis of the captured spectrum to be carried out in a first step using the second analyzing neural network and for the result to be output. This makes it possible to determine within a short process time whether the element or elements to be analyzed are contained in the sample. In some cases, one such analysis may be sufficient. In this case, the process can be terminated. In most cases, however, a statement about the concentration of the element(s) is required. In this case, the qualitative analysis is followed by the quantitative analysis with the first neural network. Due to the training of the neural network with a large number of simulation spectra, a very precise determination of the concentration of the element(s) in the sample can be made within a very short evaluation time. Alternatively, both the quantitative analysis and the qualitative analysis can be carried out simultaneously. It is understood that only the quantitative analysis can be carried out with the first neural network.

The problem underlying the invention is further solved by a device for carrying out a spectral analysis for determining the spectrum of a sample, in particular for carrying out the method according to one of the embodiments described above, which comprises a source for emitting a primary radiation onto the sample and a detector for detecting a secondary radiation which is emitted after excitation of the sample with the primary radiation, wherein a computer-assisted evaluation device evaluates the at least one detected spectrum by the detector, wherein at least one analyzing neural network with at least one first network architecture for the quantitative analysis of the spectrum and at least one second network architecture with a second analyzing neural network for the qualitative analysis of the spectrum is provided, as well as an output device which outputs a result of the at least one spectrum analyzed by the at least one neural network for the at least one element concentration and/or the at least one element identification of the sample.

The problem underlying the invention is further solved by a computer program for carrying out a spectral analysis for determining a spectrum of a sample, which is provided in particular for the evaluation device of the aforementioned apparatus, the computer program being provided on at least one computer-readable storage medium, which can be executed in the computer-assisted evaluation device and causes the evaluation device to carry out a method according to one of the above embodiments.

The invention and other advantageous embodiments and further embodiments thereof are described and explained in more detail below with reference to the examples shown in the drawings. The features to be taken from the description and the drawings can be used individually or in any combination in accordance with the invention. It shows:

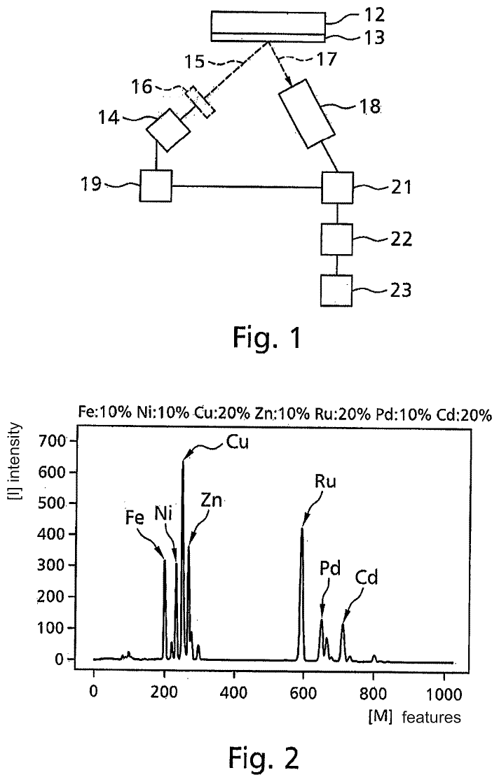

FIG. 1 a schematic view of a device for carrying out a spectral analysis,

FIG. 2 a diagram of a spectrum of an alloy determined by spectral analysis,

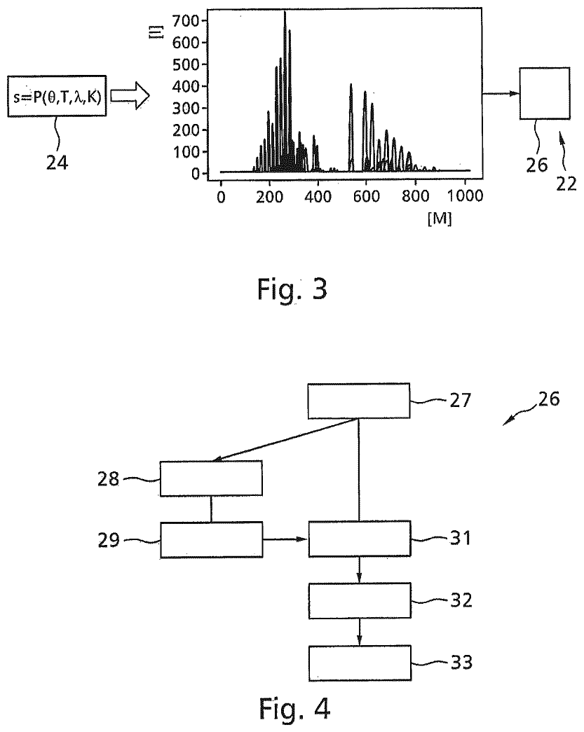

FIG. 3 a schematic view for training a neural network with simulation spectra,

FIG. 4 a diagram of a first network architecture of the neural network,

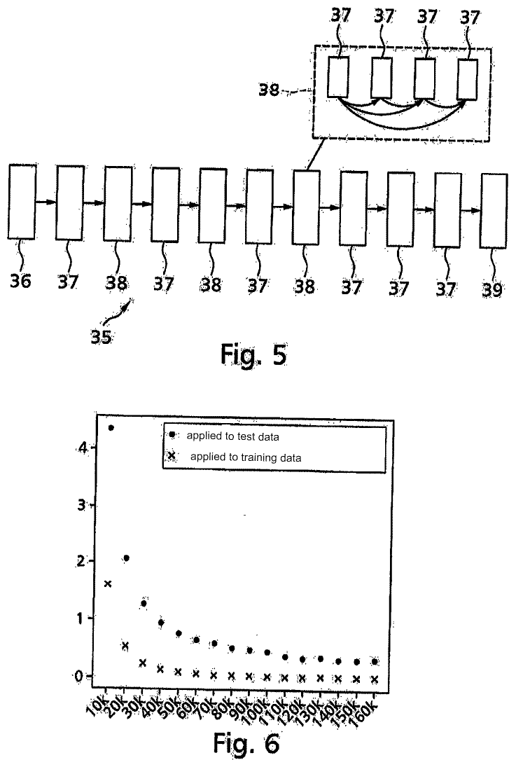

FIG. 5 a schematic view of a network structure for the network architecture shown in FIG. 4,

FIG. 6 a diagram showing a comparison between test losses before and after training the neural network,

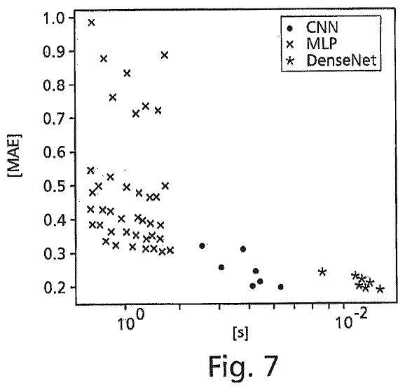

FIG. 7 a diagram showing the evaluation times of different network structures,

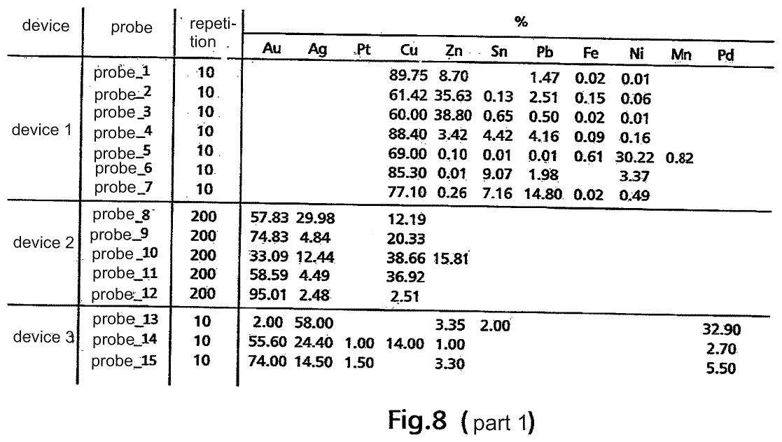

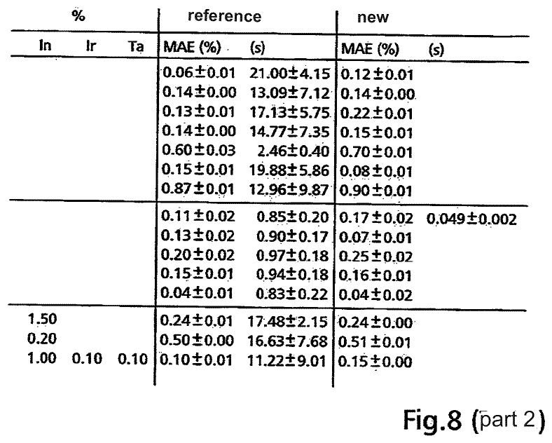

FIG. 8 a table with a comparison of evaluation times between conventional measuring devices and measuring devices supported by a neural network,

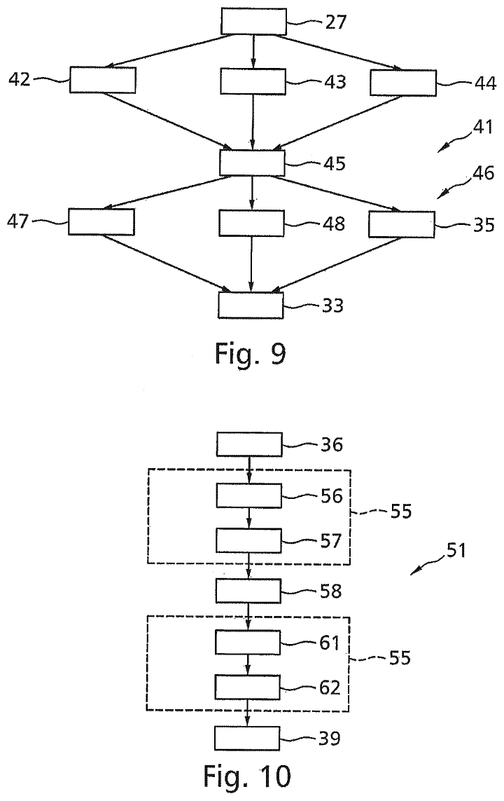

FIG. 9 a schematic view of a second network architecture for the qualitative analysis,

FIG. 10 a schematic view of a network structure for the second network architecture,

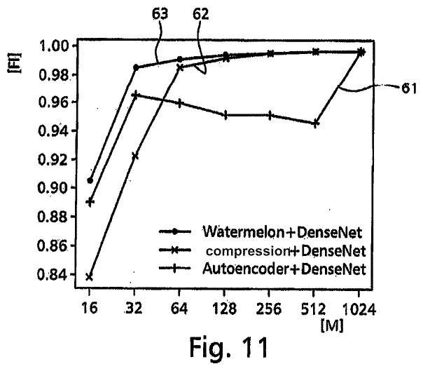

FIG. 11 a diagram illustrating the performance of feature reduction methods applied to a neural network,

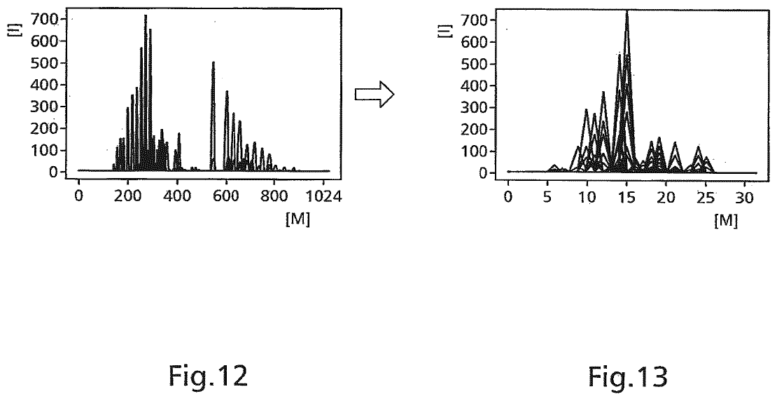

FIG. 12 a schematic view of a spectrum with a full number of features,

FIG. 13 a schematic view of a spectrum with a reduced number of features,

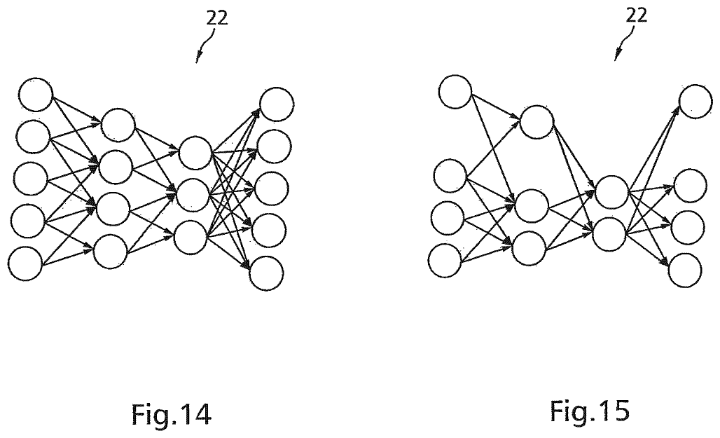

FIG. 14 a schematic view of a data size of a neural network,

FIG. 15 a schematic view of a reduced data size of the neural network in FIG. 14,

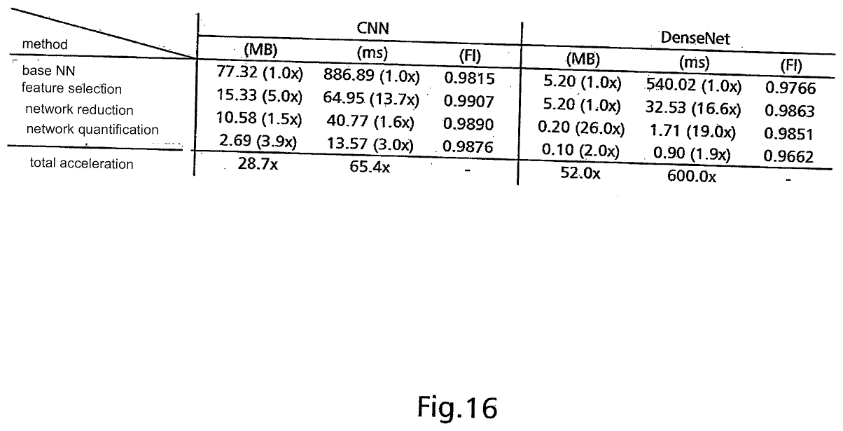

FIG. 16 a table showing the time reduction of the evaluation time of different feature reduction methods when using different neural networks,

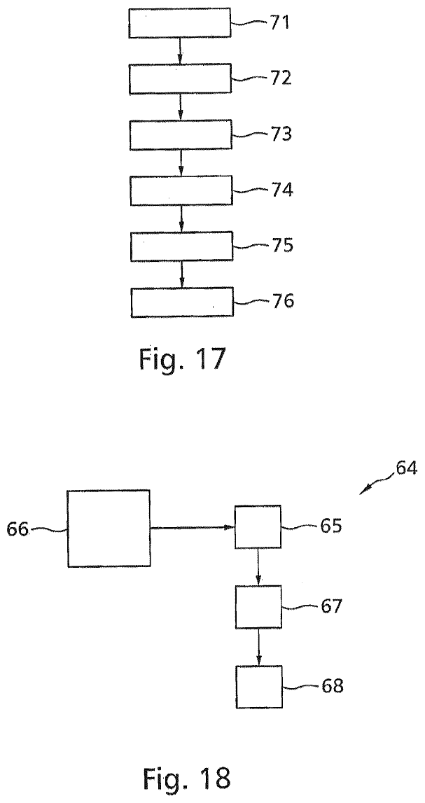

FIG. 17 a view of steps for training a neural network for high performance spectral analysis, and

FIG. 18 a schematic sequence for a meta-learning procedure for calibrating measuring devices.

FIG. 1 schematically shows a device 11 for carrying out a spectral analysis to determine a spectrum of a sample 12. This device 11 comprises a source 14 for generating a primary radiation 15. This primary radiation 15 is directed onto the sample 12. A focusing element 16, for example an optical lens or a collimator or the like, can be provided between the source 14 and the sample 12. The primary radiation 15 emits a secondary radiation 17 in the sample 12 or in at least one layer 13 on the sample 12, which is detected by a detector 18. This device 11 comprises a controller 19 by which at least the source 14 is controlled. The detector 18 converts the detected secondary radiation 17 into a spectrum and forwards this to an evaluation device 21. This evaluation device 21 is located, for example, in a spectrometer. This evaluation device 21 comprises a neural network 22, which evaluates the data recorded by the evaluation unit 21. A display device 23 outputs the determined result based on the trained neural network 22.

The device 11 can, for example, be an X-ray fluorescence fluorescence measuring device in which the source 14 is designed as an X-ray tube and the detector 18 comprises an A/D converter in order to detect the energies of the secondary radiation 17 and convert them into so-called channels and output them. Indices of these channels are proportional to the detected energy. The detected energy or the output channel is referred to below as a feature.

Alternatively, the device 11 can, for example, be designed to perform laser-induced breakdown spectroscopy (LIBS) and the source 14 is designed as a laser source. The detector 18 is designed as a spectrometer for detecting emitted light.

FIG. 2 shows a diagram of a spectrum of an alloy that is determined by the device 11. The elements contained in the alloy are represented in the spectrum by fluorescence lines of different intensities I, which are plotted along the Y-axis, as well as corresponding fluorescence line energies, which correspond to the indices of the channels, which are each plotted in a feature M along the X-axis. The concentration/layer thickness of the chemical element in the layer 13 or the sample 12 can be determined via the intensity. The chemical element can be detected by assigning the intensity to the respective feature.

The basis for the output of such a spectrum by the evaluation device 21 is an abstract physical model S=P(θ, T, λ, K), where θ denotes the concentration of the chemical element, T denotes the layer thickness on an object, λ denotes the measurement conditions during the measurement by the device 11 and K denotes the characteristic properties of the device 11. In the previous classical method for determining, for example, an element concentration based on the physical model, parameters were initially fixed and, after the measurement with the device 11, the recorded values of the element concentration were optimized in an iterative process until the theoretical spectra matched the measured spectrum as closely as possible in order to output a result.

This is accompanied by the problem that the evaluation time is high and the measurement conditions and measurement properties and, if necessary, the calibration must be known. Based on this, the aim is to enable fast and precise evaluation of the measurement results by using at least one neural network or neural network. In addition, it should be possible to use at least one neural network on different end devices.

The use of an analyzing neural network, which is trained and structured as described below, makes it possible to capture complex non-linear functions very precisely. It was also found that an inverse function P⁻¹(S) can be approximated by at least one neural network. This is not possible with the previous spectral analysis.

Against this background, it is proposed to propose a neural network for spectral analysis of the device 11, which at least accelerates the quantitative analysis and enables it to be performed with a high degree of precision.

For the quantitative analysis of element concentrations, it is necessary to train the neural network with a large number of spectra, in particular simulated spectra. This training can be based on the physical model S=P(φ), where φ stands for θ, T, K, on the basis of specific parameters of the samples 12 and/or specific parameters of the device 11 based on at least one simulation method. The training can also be based on randomly selected or set parameters. Training can also be carried out using actually recorded features of the spectra. A combination can also be provided. A large number of spectra can be generated using the simulation method. Advantageously, the neural network is trained with 80,000 to 150,000 spectra.

FIG. 3 shows that, starting from the physical model (S=P(φ)) 24, a large number of spectra are generated in accordance with FIG. 25, by means of which the neural network 22 of the first network architecture 26 is trained.

The neural network 22 is based on neurons and comprises an input layer, one or more hidden layers and an output layer. For example, a single-layer network (MLP—multilayer perceptrons) may be provided. A convolutional neural network (CNN) or a dense neural network (DNN) or other architectures, such as a dense neural network (DenseNet), can also be used.

FIG. 4 schematically shows a structure of the first network architecture 26. Starting from a captured spectrum 27, this captured spectrum 27 is evaluated by means of a scaling network 28 and modified with a scaling factor 29, for example to compensate for different excitation conditions for generating the secondary radiation 17. The spectrum 31 scaled by the scaling network 28 is evaluated with a prediction network 32 and a result 33 of the spectrum 27 obtained from the captured spectrum is output.

FIG. 5 shows a schematic view of a possible structure of the DenseNet (densely connected convolutional network) 35. This DenseNet 35 is preferably used for the scaling network 28 and/or the prediction network 32 of the first network architecture 26. For example, the DenseNet 35 may comprise an input layer 36, a convolutional layer 37, and a so-called density block (Denseblock) 38 thereafter. A further sequence of such layers, also selection-specific, takes place up to the output layer 39.

The dense block 38 is shown schematically enlarged in FIG. 5. This comprises, for example, four successive folded layers 37, each layer 37 being in contact with the adjacent one.

FIG. 6 shows a diagram indicating the number of spectra that are advantageous to train the neural network 22 in order to achieve a low error rate in the output of results. An error rate of failed tests is plotted along the Y-axis and the number of spectra is plotted along the X-axis. A comparison is shown in which the fictitious line with the round dots represents spectra after training the first network architecture 26. The fictitious line marked with a cross shows a comparison of failed tests and failed trainings. This shows that if the size of the training data of spectra is too small, this leads to an increased error rate. Furthermore, it can be seen that in a range greater than 80 k (80,000 spectra), preferably 100 k (100,000 spectra) to 160 k (160,000 spectra), there is a lower loss and a lower error rate and this range or number of spectra should be selected for training the neural network 22, in particular the first network architecture 26, in order to achieve a satisfactory result for implementation in real operation.

FIG. 7 shows a schematic diagram in which various networks for the application in the first network architecture 26 are compared with each other. The detected mean error (MAE) is plotted along the Y-axis and the response time in seconds for the output of the result is plotted along the X-axis. It is evident that the use of the CNN architecture and in particular the DenseNet architecture leads to the shortest evaluation times in comparison with the MLP architecture when used in the first network architecture 26.

FIG. 8 shows an overview of the results of evaluations of measured spectra on different samples 12 with different devices 11. A comparison is made between the previously known evaluation in the Reference column and the application of the trained first network architecture 26 for the quantitative analysis in the New column. For the comparison, the mean absolute error rate MAE in percent and the evaluation time in seconds are shown in each case. The mean error rates differ from each other to a negligible extent. By using the first network architecture 26, a significant reduction in the evaluation time is achieved with an average duration of 0.049+/−0.002 seconds. This corresponds to a factor of at least 20 times compared to the reference. It is obvious from this that a significant reduction in the evaluation time could be achieved by the trained first network structure 26 with a high number of simulation spectra, in particular between 80,000 and 160,000 spectra. The mean absolute error (MEA) remains approximately the same in comparison with the conventional quantitative analysis and the quantitative analysis supported by the first network architecture 26.

A qualitative analysis of the spectrum to identify the chemical element of the sample 12, whether it is present or absent, can be performed analogously to the quantitative analysis by training the neural network with several actually detected and/or simulated spectra 27 of different pure elements.

For the qualitative analysis relating to element identification, a second or further network structure 41 is preferably provided for outputting a result from the captured spectrum 27. Such a second network structure 41 is shown in FIG. 9. Based on the simulated spectra 27, one or more feature reduction methods can be selected for evaluation. One of the feature reduction methods relates to a mean value compression 42. Another feature reduction method can be a feature selection 43. In addition, a feature transformation 44 may be performed as a feature reduction method. Using one of these methods 42, 43, 44, a pre-processed spectrum 45 is determined. This pre-processed spectrum 45 is fed to a second neural network 46, for example with a network architecture MLP 47, CNN 48 or DenseNet 35, and a result 33 is subsequently output, in which the identified chemical element is indicated.

In the mean value compression 42, it is preferably provided that, of the features of the spectrum 27 to be evaluated, the number of features of the determined spectra are reduced to a target spectrum by averaging.

In feature selection 43, the number of features can be reduced based on a complete spectrum. For example, the so-called watermelon model can be used. The watermelon model is based on a Bayesian error rate estimation. First, this model uses kernel density estimation to approximate the true distribution of the data. A Bayesian error rate estimate is then calculated and the features are evaluated individually according to their independence or redundancy. The redundant features are determined.

During the feature transformation 44, the features of the respective spectrum 27 are preferably weighted according to relevant and non-relevant features and the non-relevant features in the spectrum are eliminated.

The feature transformation 44 can, for example, be performed by a network architecture as shown in FIG. 10. This is a so-called autoencoder 51. Starting from an input layer 36, the spectrum 27 is fed to an encoder 55, which has, for example, at least a first and second dense layer 56, 57, and comprises at least one further dense layer 58 between the encoder 55 and a subsequent decoder 59. At least one sealed layer 61, 62 can be provided in the decoder 59. The output layer 39 in turn adjoins the decoder 59.

These previously described procedures are used to train the neural network 22, for example with the first network architecture 24 and/or the second network architecture 41. After this training, the neural network 22 can be further optimized to reduce the evaluation time and/or the computing power.

FIG. 11 shows a diagram in which the feature reduction methods are plotted as a function of the number of features in the spectra 27 and as a function of different reduction methods. A factor is plotted along the Y-axis, which indicates the accuracy output of the result with the factor FI from the detected spectrum in a range between 0 and 1, where 1 corresponds to 100% accuracy. The number of features per spectrum 27 is plotted along the x-axis. The line 61 shows a performance curve when using the autoencoder 55 according to FIG. 11. The line 62 shows the performance curve with the compression method 42 and the line 63 shows the performance curve with the feature selection 43, whereby the Watermelon model was selected in particular. All three feature reduction methods 42, 43, 44 were based on a DenseNet 35 as neural network 22. It can be seen from this that a high accuracy of >92% can be achieved in all three cases in the range of a reduction of the features per spectrum from, for example, 1024 to up to 32 features. The two reduction methods according to line 62 and line 63 enable a significantly improved accuracy of the determined spectrum than is the case with the reduction method according to line 61. Thus, feature selection and in particular the Watermelon model is the preferred feature reduction method, in particular of the first and/or the second network architecture 26, 41, to reduce the evaluation time.

A further feature reduction can consist of specifically reducing the number of features of the spectra 27. FIG. 12 shows several spectra analogous to the spectrum in FIG. 2, which is plotted along the x-axis over 1024 features, for example. In the spectra shown in FIG. 13, the number of features of the spectra 27 has been reduced, for example from 1024 features to 32 features. For this feature reduction, the feature selection described above can also be carried out, for example.

Furthermore, a network reduction of the neural network 22 can be used to speed up the evaluation time. In such a network reduction, the network architecture can be checked in a first step to determine which neurons, filters or parameters impair performance. Redundant components in particular are then eliminated. In a second step, the parameter size and the floating point operations (FLOPs) can be reduced within the network reduction method. For example, according to FIG. 14, a neural network 22 is symbolically shown in order to verify the number of features of the spectrum 27 according to FIG. 12. In FIG. 15, a reduced neural network 22 is shown symbolically compared to that in FIG. 14, which can be trained by a spectrum 27 according to FIG. 14. The data size of the neural network 22 according to FIG. 14 is, for example, 5.2 MB and the computing time is, for example, 540 ms. In FIG. 15, the reduced neural network 22 has a data size of, for example, 0.1 MB and a computing time of, for example, 0.9 ms. This clearly shows the advantages of network reduction.

Furthermore, the evaluation time of the neural network 22 can be shortened by network quantization. Usually, a bit size of 32 bits is used for the floating point operations (floats). The network quantization is intended to reduce the bit size for the floating point operations to a bit size lower than 32 bits and/or an integer representation (int). Preferably, the quantization can reduce the bit size to 16-bit floats or 8-bit ints or, for example, to 8-bit ints with 16-bit activations. For example, the data size can be reduced by approx. 50% by quantizing from 32-bit float to 16-bit float. The same applies to further bit reduction.

FIG. 16 shows another table from which a performance comparison of the various reduction methods is shown. The data sizes (MB) and the evaluation time (ms) as well as the accuracy with the factor (FI) are compared with each other. In addition, the application of a CNN architecture 48 on the one hand and a DenseNet architecture 35 on the other are compared. The first line of the table shows under “Base” the neural network 22 of the first and/or the second network architecture 26, 41 without performing feature reduction and/or network reduction and/or network quantization

The feature selection 43 can already achieve a considerable reduction in data size by a factor of 5 in the CNN architecture 48 compared to the base. The data size for the DenseNet architecture remains the same. A 13.7-fold reduction in the evaluation time for the CNN architecture 48 and a 16-fold reduction for the DenseNet architecture 35 can be achieved. The accuracy of the result remains virtually the same when using feature selection compared to the basis

The network reduction method and/or the network quantization method can further reduce the data size and the evaluation time, as can be seen in the table. However, the accuracy of the results remains same compared to the baseline.

An optional combination of the three reduction methods listed, i.e. feature reduction, network reduction and/or network quantization, can also be used in combination. If all three reduction methods are superimposed in order to optimize the neural network 22, the CNN architecture 48 can reduce the data size by a factor of approximately 29 and the evaluation time by a factor of 65. With the DenseNet architecture 35, the file size can even be reduced by a factor of 52 and the evaluation time by a factor of 600. Thus, it is obvious that by feature reduction, in particular by feature selection, of the spectra for quantitative and/or qualitative analysis on the one hand and by training the neural network 22 with these spectra r and preferably an additional network reduction and/or network quantization of the neural network 22, not only the computational effort can be reduced and thus the costs reduced, but also the evaluation times can be shortened by a considerable amount.

FIG. 17 shows a preferred embodiment for training the neural network 22. This embodiment is particularly suitable for a production of a high number of devices, in particular mass production, whereby the evaluation time is considerably reduced with a high accuracy of the results. In a first step 71, the neural network 22 is trained by the actually detected spectra and/or by spectra simulated by a simulation method for qualitative and quantitative analysis. Preferably, the number of simulated spectra is greater by a multiple, in particular by a factor of at least 100, than the number of actually detected spectra. The training is based on a second network structure 41, which is described in more detail in FIG. 9, in order to train the first network architecture 26 on the chemical elements. In a further step 72, an analogous procedure as in step 71 for the quantitative analysis is carried out, as shown in FIGS. 4 and 5. In particular, this provides for pre-processed spectra to be recorded from the determined spectrum 27 using the feature reduction method of feature selection 42, which are then trained using the DenseNet.

Based on this, the feature selection 42 described in FIGS. 12 and 13 is selected in a further step 73 for feature reduction. Subsequently, in step 74, the pre-processed spectra of the first and/or second network architecture 26, 41 are used as a basis. Subsequently, the network reduction is performed in step 75 and then the network quantization is performed in step 76. In this way, a process-optimized method for carrying out the spectral analysis can be created, particularly for large-scale production, in which a reduction in data size of up to 52 times and a reduction in evaluation time of up to 600 times can be achieved compared to conventional methods. At the same time, it is possible to use conventional measuring devices with reduced computing power.

FIG. 18 shows a schematic view of a meta-learning method 64 with a meta-network 65. Such a meta-learning method 64 is used in particular for the calibration of devices 11 or measuring devices manufactured in a factory. In addition, it is often necessary to recalibrate the devices 11 after a certain period of operation in order to correct any drift that may occur during operation of the measuring device.

In the meta-learning process 64, it is intended that information is learned with different tasks so that a meta-network can quickly adapt to a new unknown task, in particular device 11. In a first step 66, spectra 27 are recorded from a sample 12 using a known measuring device 11 under different measurement conditions. These spectra 27 are evaluated by a first network architecture 26 of the neural network 22. Spectra are then determined and/or simulation spectra are generated from further samples 12 with further known measuring devices 11, in which not only the various measurement conditions but also various characteristic properties of the measuring device 11 are taken into account. These spectra from the at least one known device 11 are used in step 66 to train a meta-network 65. An agnostic meta-learning model (MAML—Model-Agnostic Meta-Learning) can be used for this purpose. The meta-network 65 is thus trained for the calibration of the devices 11.

To calibrate an unknown measuring device 11, the meta-network 65 is first trained with measurement conditions and/or measurement properties of the unknown measuring device 11 in step 67. Subsequently, the unknown measuring device 11 is calibrated by the meta-network 65. Advantageously, the calibration of the unknown measuring devices 11 can be performed without measuring a sample 12. Alternatively, at least one measurement can also be carried out on the unknown measuring device 11. In this case, the meta-network 65 is further trained, whereby an improved calibration is performed on the unknown measuring device 11.

After a predetermined or longer period of operation of the measuring device 11, recalibration may be necessary in accordance with step 68. Measurement data of the measuring device 11 to be recalibrated is recorded, so that the meta-network 65 is again trained by this measurement data. Due to the further training of the meta-network 65 by the measuring device 11 to be recalibrated, the meta-network 65 can be trained further and perform a faster and improved recalibration.

The meta-learning process 64 is preferably divided into two processes, namely training before calibrating the unknown measuring device 11 and training after calibrating the then known measuring device 11. The meta-learning process 64 can enable high cost savings for the industry and the customer.

1. Method for carrying out a spectral analysis for evaluating a spectrum of a sample,
with a measuring device,
in which a primary radiation is directed from a source onto the sample,
in which secondary radiation is emitted by the sample or at least one layer of the sample as a result of the excitation of the sample by means of primary radiation,
in which a spectrum of the secondary radiation is detected by a detector,
in which the at least one detected spectrum is fed by the detector for evaluation to a computer-assisted evaluation device, in which the at least one detected spectrum is evaluated in at least one analyzing neural network of at least one first network architecture, which is trained for quantitative analysis of the spectrum,
in which the neural network of the first network architecture is trained by a plurality of simulation spectra generated from a physical model (S=P(φ)) using a simulation method,
in which at least a second network architecture is trained with a second analyzing neural network for the qualitative analysis of the detected spectrum,
in which a concentration and/or an identification of the at least one element of the sample is output as a result from the spectrum analyzed by the neural networks.

2. Method according to claim 1, wherein the neural network of the at least one network architecture is trained to approximate an inverse function P⁻¹(S), so that in the quantitative analysis the at least one element concentration of the detected spectrum of the sample is determined and output and/or in the qualitative analysis the absence or presence of at least one chemical element of the detected spectrum of the sample is determined and output.

3. Method according to claim 1, wherein the neural network of the first network architecture is trained by a plurality of simulation spectra which are generated on the basis of the physical model (S=P(θ, T, λ, K)) using a simulation method and/or in that the first network architecture is trained using a plurality of actually detected spectra.

4. Method according to claim 3, wherein the simulation spectra are determined with predetermined parameters, in particular with the concentration of the chemical element or concentrations of the at least one element of an alloy, element-specific physical constants, the layer thickness of at least one layer, different measuring conditions of the measuring devices and/or characteristic properties and/or device-specific data from the one or different measuring devices.

5. Method according to claim 1, wherein the neural network of the second network architecture is trained with a plurality of spectra of at least one chemical element, which differ from one another, which are determined by X-ray fluorescence analysis.

6. Method according to claim 1, wherein a scaling network is used for the quantitative analysis of the detected spectrum in the first network architecture, in which the at least one detected spectrum of the sample is adjusted with a scaling factor, in order to compensate for one or more different excitation conditions, and in that the scaled spectrum is subsequently fed to a prediction network and a result of the spectrum is output by this prediction network.

7. Method according to claim 6, wherein the prediction network and/or the scaling network is constructed with a neural network.

8. Method according to claim 3, wherein at least one feature reduction method is applied to the generated simulation spectra for quantitative analysis and/or for qualitative analysis of the generated spectrum, and in that, starting from a plurality of simulation spectra and/or detected spectra, preprocessed spectra are generated using the at least one feature reduction method and the neural network is trained using these preprocessed spectra.

9. (canceled)

10. Method according to claim 8, wherein the number of features of the spectrum to be evaluated is reduced from 1024 to 512, 256, 128, 64, 32 or 16 features by the one feature reduction method.

11. Method according to claim 25, wherein
the feature reduction method is performed as a mean value compression in which the number of features of the detected spectrum and/or simulation spectra is reduced to a target spectrum by averaging, and/or
the feature reduction method is performed as a feature selection in which a reduction in the number of features of the respective spectrum is performed starting from their original size and reduced to a preprocessed spectrum, and/or
the feature reduction method is carried out as a feature transformation, preferably with an autoencoder network, in which a weighting of the features of the respective spectrum is carried out according to relevant and non-relevant features and the non-relevant features are eliminated.

12. Method according to claim 11, wherein the feature selection is carried out using a watermelon model, in which the selection of the features is carried out by Bayesian error rate estimation.

13. Method according to claim 1, wherein the analyzing neural network is trained with at least one further model for reducing the evaluation time after the simulation of the spectra and/or reduction of the spectra for the quantitative analysis and/or the selection of the chemical elements for the qualitative analysis.

14. Method according to claim 13, wherein the analyzing neural network after the simulation of the spectra and/or reduction of the spectra for the quantitative analysis and/or the selection of the chemical elements for the qualitative analysis, is trained with a model for network reduction, in which the neural network is reduced by components, such as neurons, filters and/or parameters and/or by redundant components.

15. The method according to claim 14, wherein a filter reduction is performed on the neural network comprising folded layers and/or a neuron reduction is performed on the neural network comprising dense layers.

16. Method according to claim 13, wherein the analyzing neural network, after the simulation of the spectra and/or reduction of the spectra for the quantitative analysis and/or the selection of the chemical elements for the qualitative analysis, is trained with a model for quantization in which the data size.

17. Method according to claim 1, wherein the measuring device is trained by a neural network of a meta-network by simulation data from a number of known measuring devices for performing a meta-learning procedure for unknown measuring devices.

18. Method according to claim 17, wherein for calibrating unknown measuring devices for spectral analysis, the meta-learning method with the meta-network is used, in which the properties and/or the changing measurement conditions and/or the measurement tasks of the measuring device to be calibrated are recorded, and the meta-network is additionally trained by simulation data and/or measured data of the unknown measuring devices.

19. Method according to claim 17, wherein the meta-network is made operational by the training at least for the quantitative analysis of the unknown measuring device.

20. Method according to claim 19, wherein the analyzing neural network is constructed at least as a multilayer network (MLP), a convolutional neural network (CNN) or a dense neural network (DNN) or a dense convolutional network (DenseNet).

21. Method according to claim 1, wherein the qualitative analysis is carried out in a first step to examine the sample and the quantitative analysis of the sample is carried out for further analysis of the sample.

22. Method according to claim 1, wherein the source is formed as an X-ray tube and an X-ray radiation is emitted.

23. Measuring device for carrying out a spectral analysis to determine the spectrum of a sample,
with a source for emitting a primary radiation onto the sample,
with a detector for detecting a secondary radiation which is emitted after excitation of the sample by means of primary radiation,
with a computer-assisted evaluation device which evaluates the at least one detected spectrum of the detector,
wherein at least one analyzing neural network with at least a first network architecture is provided for quantitatively analyzing the spectrum,
wherein at least a second network architecture with a second analyzing neural network is provided for the qualitative analysis of the spectrum, and
having an output device which outputs a result of at least one spectrum analyzed by the at least one neural network for a concentration and/or an identification of the at least one element of the sample.

24. A computer program for performing a spectral analysis to determine a spectrum of a sample, wherein the computer program is provided on at least one computer-readable storage medium which is executable on a computer system and causes the computer system to perform a method according to claim 1.

25. Method according to claim 7, wherein the prediction network and/or the scaling network is constructed with a dense convolutional network (DenseNet), which comprises at least one dense block with convolutional layers (DenseBlock), in which each layer within the block is in contact with the other layers.
